(19) United States
(12) Patent Application Publication
(10) Pub. No.: US 2009/0034862 A1
(43) Pub. Date: Feb. 5, 2009

(54) System and Method for Image Profiling

(76) Inventors: Patrick M. Brown, Holbrook, NY (US); William J. Sakoda, (US); David S. Koch, Islip, NY (US)

Correspondence Address: Fay Kaplun & Marcin, LLP/ Motorola, 150 Broadway Suite 702, New York, NY, 10038, US

(21) Appl. No.: 11/831,254

(22) Filed: Jul. 31, 2007

(51) Int. Cl. G06K 9/40

(52) U.S. Cl. 382/260

(57) ABSTRACT

Described are a system and a method for image profiling. Image data is generated from an image engine of an electronic device. An image file is created from the image data. A profile that is unique to the image file is generated. The profile includes data relating to the electronic device and the image file. The profile is attached to the image file.

### FIELD OF THE INVENTION

The present invention relates generally to a system and method for image profiling. Specifically, when an image is created with an electronic device, profile data is attached thereto.

### BACKGROUND

An image capturing device may receive image data to create an image file. For example, a digital camera may take a photograph and create a corresponding file. The image file may subsequently be moved, altered, etc. The image file that is created may be generic with no specific identifying associations. That is, characteristics of the image file such as quality, image file type, etc. may be used to identify only broad traits relating to the image capturing device. The image file may not be used to identify the specific device that created the image file. Furthermore, when alterations are made to the image file, even the broad traits may be lost, thereby further losing any identifying associations of the image file.

### SUMMARY OF THE INVENTION

The present invention relates to a system and a method for image profiling. Image data is generated from an image engine of an electronic device. An image file is created from the image data. A profile that is unique to the image file is generated. The profile includes data relating to the electronic device and the image file. The profile is attached to the image file.

The present invention also relates to a device which includes an image engine capturing an image. The image is converted into an image file. The device also includes a profile generator which creates a profile that is unique to the image file. The profile includes data relating to the device and the image file. The profile is attached to the image file.

### DESCRIPTION OF THE DRAWINGS

FIG. 1 shows an internal view of an image capturing device according to an exemplary embodiment of the present invention.

FIG. 2 shows a method for profiling an image file according to an exemplary embodiment of the present invention.

FIG. 3 shows a method for utilizing a profile that has been attached to an image file according to an exemplary embodiment of the present invention.

### DETAILED DESCRIPTION

The present invention may be further understood with reference to the following description and the appended drawings, wherein like elements are referred to with the same reference numerals. The exemplary embodiments of the present invention describe a system and method for profiling an image file. Specifically, the exemplary embodiments of the present invention utilize a profile that is specific to the image file. The profile may be attached to the image file. As will be discussed in further detail below, the exemplary embodiments of the present invention may incorporate the profile for when an electronic device creates image files. The image capturing device, the profile, and the created image file will be discussed in more detail below.

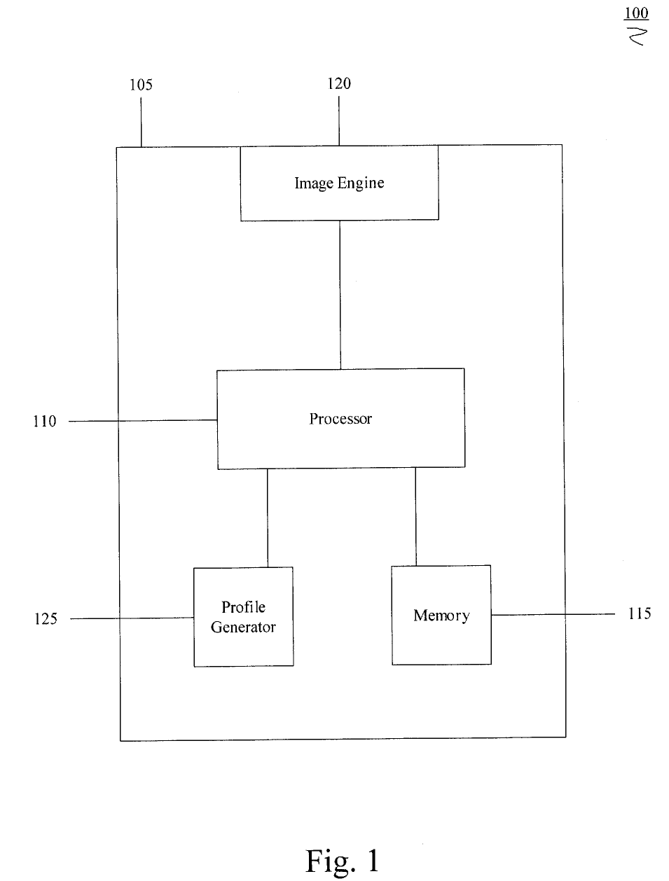

FIG. 1 shows an internal view of an image capturing device 100 according to an exemplary embodiment of the present invention. The image capturing device 100 may be, for example, a mobile unit equipped with a camera. It should be noted that the image capturing device 100 may include further components (not shown) and corresponding functionalities. For example, as a mobile unit, the image capturing device 100 may further be equipped to connect to a network, execute programs installed thereon, etc. Thus, the image capturing device 100 may also include a radio and an antenna to connect to the network, a data input arrangement for the various programs, etc. Because the image capturing device 100 may include the camera (i.e., an image creating component), the image capturing device 100 may also include components associated with photography such as a stand, a flash, etc.

It should be noted that the image capturing device 100 being a mobile unit is only exemplary. The image capturing device 100 may be a module that connects to a terminal. The connection may be wireless if the image capturing device 100 is a mobile unit or may be wired using a connector. The connector may include a first end that is received by the image capturing device 100 via a port (not shown) with a second end being received by the terminal. As illustrated, the image capturing device 100 may include a housing 105, a processor 110, a memory 115, an image engine 120, and a profile generator 125.

The housing 105 may provide a casing that at least partially holds the components of the image capturing device 100. For example, the processor 110, the memory 115, and the profile generator 125 may be disposed wholly within the housing 105. In another example, if the image capturing device 100 is a mobile unit, the antenna (not shown) may be disposed partially within the housing 105 and extend partially outside the housing 105. The data input arrangement (not shown) may also extend from within the housing 105 beyond a face of the housing 105 to allow a user to enter inputs.

The processor 110 and the memory 115 may be conventional components found in electronic devices. That is, the processor 110 may be equipped to execute the various programs and functionalities of the image capturing device 100. In particular, the processor 110 may execute a program for attaching a profile to an image file. The memory 115 may be equipped to store data for the image capturing device. In particular, the memory 115 may store the image file with the attached profile for subsequent retrieval so that a user may, for example, edit, send, etc. the image file. It should be noted that the memory 115 may be a conventional flash memory that is used for conventional cameras or any other type of non-volatile memory. The memory 115 may also be a volatile memory such as random access memory (RAM).

The image engine 120 may capture images to create corresponding image files. The image engine 120 may include various components. For example, the image engine 120 may include the components to create image data such as the components of a digital camera. The components of the camera may include, for example, at least one lens, a shutter, an image sensor, a light converter, etc. It should be noted that the various components of the image engine 120 may be disposed as separate units that are disposed within the housing 105.

The profile generator 125 may provide the profile that is to be attached to an image file. The profile may include a variety of specific identifying associations. For example, the profile may include specific device identification data. Thus, the profile generator 125 may create the profile to indicate a manufacturer, a model, an owner of the image capturing device 100, etc. As will be discussed in detail below, the profile may include further specific identifying associations. It should be noted that the profile generator 125 being disposed as a separate unit is only exemplary. For example, the processes of the profile generator 125 may be executed by the processor 110 through a program installed thereon and stored in the memory 115.

In a first embodiment, the profile generator 125 may create the profile as a global unique identifier (GUID). The GUID may be, for example, a 256 bit unique key. The GUID may be attached to the image file in a variety of locations. For example, the image profile may be attached to a lower order bit such as on an end row and/or column in a two-dimensional image. In another example, the profile may be stored utilizing pixels at one or more boundaries of the image. An additional row of pixels may be attached to a bottom boundary or the image; or an ultimate edge of pixels may be replaced in, for example, a one pixel width that stores the profile. In another yet example, the image file may include a header. Thus, the profile may be attached to a header of the image file so that the image capturing device 100 may readily ascertain the properties of the image file when the header is read.

In a second embodiment, the profile generator 125 may create the profile as a serial number. Similar to a conventional serial number for a device, the serial number may be specific to the image created by a particular image capturing device 100. Thus, the image capturing device 100 may include, for example, a preset plurality of numbers that identify the image capturing device. The serial number may include, for example, a further image specific plurality of numbers in conjunction with the preset plurality of numbers that identify the image file. The image specific plurality of numbers may, for example, start at an initial value and increase as more image files are created by the image capturing device 100. Therefore, each image file created by the image capturing device 100 may have a serial number that includes the preset plurality of numbers and an image specific plurality of numbers.

In a third embodiment, the profile generator 125 may create the profile as a global position (GP). The image capturing device 100 and/or a terminal connected thereto may be equipped with a global positioning system (GPS). The GPS may relay the GP. The GP may be used to provide validation of a location in which a picture is taken. That is, the GP may be specific to the picture and the image capturing device 100. The GP may include latitude and longitude data of the image capturing device 100 at the time the picture was taken.

In a fourth embodiment, the profile generator 125 may create the profile as a cellular position. For example, the cellular position may be relative to a wide area network (WAN). The cellular position may also be used to provide validation of a location in which a picture is taken. The cellular position may be derived from a cellular coverage of a WAN radio. The cellular position may be specific to the picture and the image capturing device 100. The cellular position may also include latitude and longitude data of the image capturing device 100 at the time the picture was taken.

In a fifth embodiment, the profile generator 125 may create the profile as a wireless local area network (WLAN) position. The WLAN position may be derived from wireless access points disposed in a wireless network that may be used and seen by a WLAN radio on the image capturing device 100 or a terminal connected thereto. The WLAN position may be used to provide validation of a location in which a picture is taken. The WLAN position may be specific to the picture and the image capturing device 100. The WLAN position may also include latitude and longitude data of the image capturing device 100 at the time the picture was taken.

In a sixth embodiment, the profile generator 125 may create the profile using a derivative of time such as a time stamp. The time stamp may be used to provide a validation of a location in which a picture is taken. The time stamp may be taken from multiple sources and cross-referenced for validation. The sources may include, for example, components from a GPS, a WAN, and a wireless network. The time stamp may be specific to the picture and the image capturing device 100. The time stamp may include, for example, a year, a month, a day, an hour, a minute, a second, and/or a millisecond of the time that the picture was taken by the image capturing device 100.

In a seventh embodiment, the profile generator 125 may create the profile as a personal watermark. The personal watermark may be used to provide validation of a user who shot a picture. The personal watermark may be formed from, for example, a password, a fingerprint, and/or another specific, private information that relates to the user shooting the picture with the image capturing device 100. The personal watermark may be taken from multiple sources so that a validation may be made through a cross-reference. These sources may include, for example, the password, the fingerprint, and/or other biometrics. The personal watermark may further be specific to the picture and the image capturing device 100.

In an eighth embodiment, the profile generator 125 may create the profile as a digital signature. The digital signature may be used to detect a tampering or alterations with the profile data and the picture. The digital signature may be formed from, for example, a final image data and any additional profile data attached to the image data. Those skilled in the art will understand that conventional detection of tampering with electronic media may be used such as cyclic redundancy calculations, encryption techniques, etc. The digital signature may be specific to the picture and the image capturing device 100.

It should be noted that the above described exemplary embodiments of the profile may be used singularly or as a combination of embodiments. That is, the profile may be one of the embodiments or be up to all eight embodiments. The profile created by the profile generator 125 may include values that may be used for a variety of purposes. That is, the profile may have certain properties that aid in identification of the image capturing device, the image file, etc. It should be noted that the following exemplary properties may apply to any form that the profile may be embodied such as the GUID, the serial number, the location, the time stamp, the personal watermark, and/or the digital signature.

The values associated with the profile may be used for verification. The values of the profile may provide, for example, a checksum. The profile may include an authentic checksum value that pertains to when the image capturing device 100 created the image file. The authentic checksum value may be an isolated, immutable part of the profile that is attached to the image file. Thus, when a subsequent check is performed through addition of components of the image file, a simple check may be performed to verify an authenticity of the image file. The checksum may be a more complicated process so that errors in verification are not overlooked. For example, the checksum may determine if the components of the image file have been reordered; any zero-valued bytes have been added or deleted; multiple errors resulting in a zero sum; etc.

As discussed above, the profile may include at least a portion dedicated to identification of the image capturing device 100. That is, this portion may be unique to each individual image capturing device. For example, the profile may be unique based on the system GUID generated for each device by each manufacturer. In another example, the profile may be a serial number that includes at least a portion based on the device serial number of the image capturing device 100. The portion may include, for example, the entire device serial number. Furthermore, the profile may include other data to identify the image capturing device 100 such as a personal watermark or digital signature.

The profile may also be encrypted. The encryption may allow the data contained in the profile to remain intact; to be interpreted only by authorized personnel; and to prevent an alteration to the data. The profile may be encrypted through the use of a key. The key may provide a process necessary to extract the values of the data contained therein. It should be noted that the use of the key for encryption is only exemplary and the profile may be encrypted with any conventional technique.

The profile may additionally include further data regarding the image file. As discussed above, the profile may include identifying associations relating to the image file. The profile may also include, for example, image parameter data such as analog/digital gain, exposure, image quality setting (e.g., pixels), dimensions, etc.

The profile may be used for authorization. That is, the profile may be used to prevent image data from being created when a picture is shot with the image capturing device 100. Conditions such as location, time, authorship, etc. may be used to permit image data from being generated. For example, pictures shot at locations with an expectation of privacy (e.g., military sites, washrooms, paid events like movies or sports events, etc.) may result in image data that is blanked, a default image indicating a non-allowance, etc.

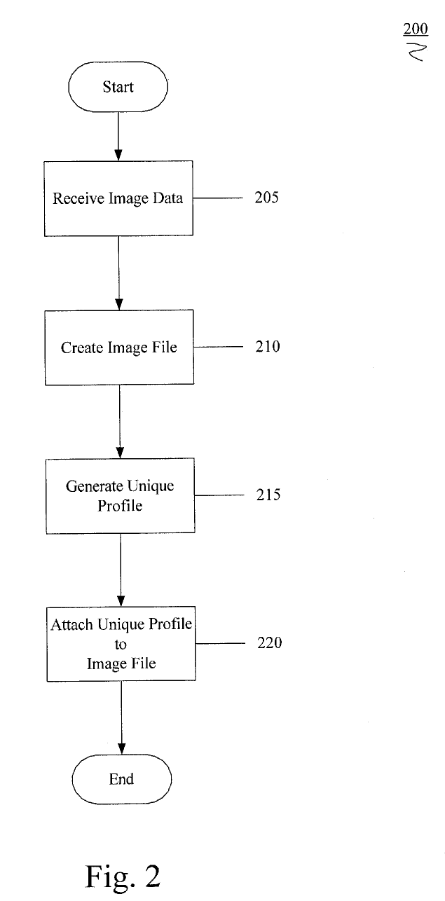

FIG. 2 shows a method 200 for attaching a profile to an image file according to an exemplary embodiment of the present invention. The method 200 will be described with reference to the image capturing device 100 and the profile generated by the profile generator 125 of FIG. 1. It should be noted that the method 200 may apply to any form that the profile may be embodied such as the GUID and the serial number.

In step 205, image data is received. The image data may be received via the image engine 120. As discussed above, the image engine 120 may be components of a camera. The camera may capture a picture. Light may be received by the image sensor and converted by the light converter. The conversion may produce the image data.

In step 210, the image file is created. The image data may be transmitted from the image engine 120 to the processor 110. The processor 110 may then convert the image data into the image file (e.g., a jpeg file, etc.). That is, the processor may execute a software application that converts the image data into an image file. The image file may correspond to a variety of factors such as an operating system of the image capturing device 100, an image program installed on the image capturing device 100, etc. It should be noted that the image file may be created by the image engine 120. Thus, the image engine 120 may transmit the image file to the processor for subsequent actions. The image file that is created may be stored in, for example, the memory 115.

In step 215, the profile is generated for the image file. As discussed above, the profile may be generated via the profile generator 125. The profile may be, for example, a GUID or a serial number. Also, as discussed above, the profile may be unique to the image data. For example, a portion of the values included in the profile may pertain to the identity of the image capturing device 100. Another portion of the values included in the profile may pertain to the identity of the created image file. Yet another portion of the values included in the profile may pertain to the image parameters.

In step 220, the profile is attached to the image file. The processor 110 may perform the attachment of the profile to the image file. As discussed above, the profile may be attached to the image file in a variety of locations. For example, the profile may be attached to a lower order bit of the image data (e.g., on the last row or column); to a header of the image data; etc.

It should be noted that the method 200 may include additional steps. These additional steps may correspond to a form in which the image data is stored. For example, if the profile is to be encrypted, a step that encrypts the profile may be included between step 215 (i.e., profile generation) and step 220 (i.e., profile attachment). In another example, the image data may also be encrypted so that the picture may only viewed by authorized users. Thus, a step may be included after step 210 where the image file is encrypted.

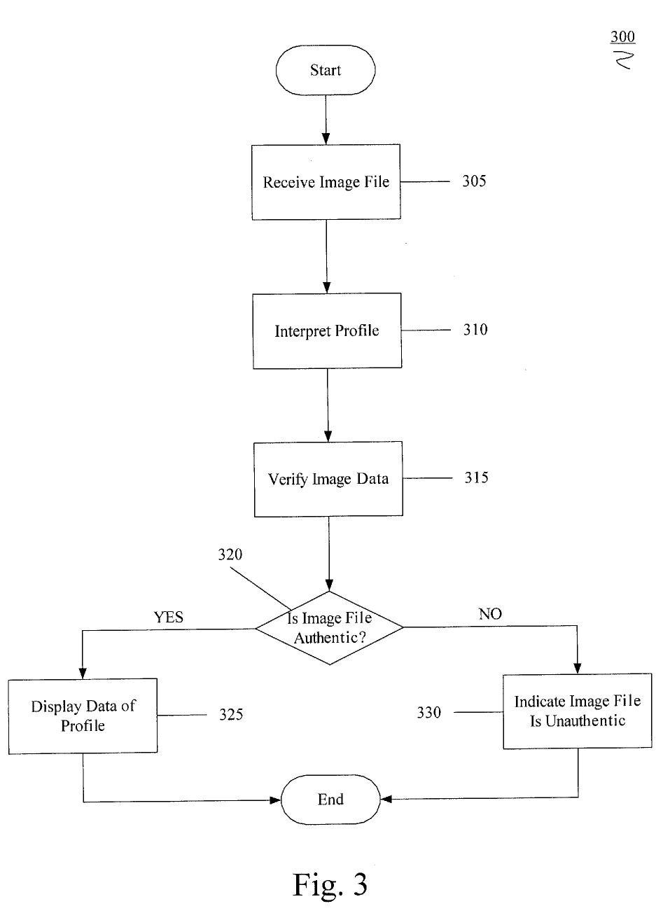

FIG. 3 shows a method 300 for utilizing a profile that has been attached to an image file according to an exemplary embodiment of the present invention. Specifically, the method 300 may pertain to a time frame after the image data has been appended with the profile. The method 300 will be described with reference to the image capturing device 100 and the profile generated by the profile generator 125 of FIG. 1. It should again be noted that the method 300 may apply to any form that the profile may be embodied such as the GUID and the serial number.

In step 305, the image file is received. The image file may be received by a variety of electronic devices. For example, the image file may be received by a computing device equipped with components that are capable of reading the profile. That is, the image file is not necessarily received by the image capturing device 100. In one example, the device that includes the image capture device may be a personal digital assistant (PDA) that also includes a communication capability to connect to a network (e.g., wireless LAN connection). The PDA may transmit the image file including the profile to a further device connected to the network (e.g., a server, another PDA, etc.).

In step 310, the profile is interpreted. The components capable of reading the profile may perform the interpretation. Furthermore, the interpretation may entail decrypting a profile that has been encrypted. Thus, if the profile has been encrypted using a key, the key may also be used to decrypt the profile. The decryption may take place in step 310.

In step 315, the image data is verified. That is, a check may be performed to determine if an alteration, a manipulation, etc. has been performed on the image data. As discussed above, the profile may include verification data such as an authentic checksum value. The components of the image data may be added and compared to the authentic checksum value to determine authenticity. It should be noted that other forms of authentication may be used to determine the genuineness of the image data.

In step 320, a determination is made whether the image file is authentic. If the image file is authentic, the method 300 may continue to step 325. In step 325, the data contained in the profile may be displayed to a user. As discussed above, the data contained in the profile may include, for example, identity data relating to the image capturing device 100, the owner of the image capturing device 100, etc. The data may further include image parameters.

If the image file is unauthentic, the method 300 may continue to step 330. In step 330, the electronic device that received the image file may indicate to the user that the image file is unauthentic. The indication may be, for example, a display. The display may include data relating to the unauthentic image file. For example, details may be shown of any alteration, manipulation, etc. that has been performed on the image file.

The exemplary embodiments of the present invention described above relating to the profile may provide invaluable data regarding an image. Specifically, the profile may provide proprietary information of the image. For example, a picture taken with a particular image capturing device 100 is owned by the owner of the image capturing device 100. Consequently, illicit use of the image capturing device 100 may be prevented, particularly when proprietary rights of a captured image is in issue. In the enterprise market, unique ownership may be established through a system's universally unique identifier (UUID) and media access control (MAC) address. Timestamp and system logo data may also be incorporated as part of the profile to further provide identifying associations. The profile including image parameters may also provide more efficient trouble shooting solutions when analyses are to be performed by, for example, a support center.

In addition, the profile attached to the image file may be used as a means to prevent unauthorized alteration or manipulation of the image file. That is, the profile may encrypt the image file so as to be a read-only file. If an alteration or manipulation is to be done, a user must first enter a key in which the image file is encrypted. The profile may also include positioning data. The image capturing device 100 or the terminal to which it is connected may determine a location of the image capturing device. Thus, when an image is captured via the image engine 120, the profile generator 125 may include the location data in the profile. For example, a profile attached to a picture of the Statue of Liberty may include that the picture was taken in New York City. A time and date stamp may also be included in this manner.

Those skilled in the art will understand that the above described exemplary embodiments may be implemented in any number of manners, including, as a separate software module, as a combination of hardware and software, etc. For example, the profile generator 125 may be a program containing lines of code that, when compiled, may be executed on the processor 110.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A device, comprising:
an image engine capturing an image, the image being converted into an image file; and
a profile generator creating a profile that is unique to the image file, the profile including data relating to the device and the image file, the profile being attached to the image file.

2. The device of claim 1, wherein the profile further includes parameter data of the image file, the parameter data being at least one of an analog/digital gain, an exposure, image quality settings, and image dimensions.

3. The device of claim 1, wherein the profile further includes an authentic checksum value, the authentic checksum value being based on the image as captured by the image engine.

4. The device of claim 1, wherein the profile prevents the image file from being created.

5. The device of claim 4, wherein, when a prevention is made, one of the image becomes blank and a display indicates an invalid area for the image to be taken.

6. The device of claim 5, wherein the authentic checksum value is used during a checksum to verify if the image file has been manipulated.

7. The device of claim 1, wherein the profile is attached to the image file in one of a lower order bit, a header of the image file, and at least one boundary of the image.

8. The device of claim 7, wherein the lower order bit of the image file is on one of a last row and a last column relating to dimensions of the image.

9. The device of claim 1, wherein the profile is at least one of a global unique identifier, a serial number, a location, a time stamp, a personal watermark, and a digital signature.

10. The device of claim 1, wherein the profile is encrypted.

11. A method, comprising:
receiving image data from an image engine of an electronic device;
creating an image file from the image data;
generating a profile that is unique to the image file, the profile including data relating to the electronic device and the image file; and
attaching the profile to the image file.

12. The method of claim 11, wherein the profile further includes parameter data of the image file.

13. The method of claim 12, wherein the parameter data is at least one of an analog/digital gain, an exposure, image quality settings, and image dimensions.

14. The method of claim 11, further comprising:
creating an authentic checksum value based on the image as captured by the image engine.

15. The method of claim 14, wherein the authentic checksum value is included in the profile.

16. The method of claim 15, wherein the authentic checksum value is used during a checksum to verify if the image file has been manipulated.

17. The method of claim 11, wherein the profile is attached to the image file in one of a lower order bit, a header of the image file, and at least one boundary of the image.

18. The method of claim 17, wherein the lower order bit of the image file is on one of a last row and a last column relating to dimensions of the image.

19. The method of claim 11, wherein the profile is at least one of a global unique identifier, a serial number, a location, a time stamp, a personal watermark, and a digital signature.

20. The method of claim 11, further comprising:
encrypting the profile.

21. A computer readable storage medium including a set of instructions executable by a processor, the set of instructions operable to:
receive image data from an image engine of an electronic device;
create an image file from the image data;
generate a profile that is unique to the image file, the profile including data relating to the electronic device and the image file; and
attach the profile to the image file.

22. A system, comprising:
an image capturing means for capturing an image, the image being converted into an image file; and
a profile generation means for creating a profile that is unique to the image file, the profile including data relating to the device and the image file, the profile being attached to the image.
